(19) United States
(12) Patent Application Publication
(10) Pub. No.: US 2017/0227038 A1
(43) Pub. Date: Aug. 10, 2017

(54) CONNECTING DEVICE, ASSEMBLY HAVING A CONNECTING DEVICE AND HAVING A SUBSTRATUM, METHOD FOR PRODUCING AN ASSEMBLY HAVING A CONNECTING DEVICE AND HAVING A SUBSTRATUM, AND SETTING TOOL FOR PERFORMING A METHOD FOR PRODUCING AN ASSEMBLY HAVING A CONNECTING DEVICE AND HAVING A SUBSTRATUM

(71) Applicant: A. RAYMOND et Cie, Grenoble (FR)

(72) Inventors: Sebastian Blum, Endingen (DE); Till Eric Ruffing, Grenzach-Wyhlen (DE); Martin Büsch, Efringen-Kirchen (DE); Martin Kurth, Kandern (DE); Johannes Gebhardt, Stutensee (DE)

(21) Appl. No.: 15/305,616

(22) PCT Filed: May 7, 2015
(86) PCT No.: PCT/EP2015/060025

§ 371 Date: Apr. 20, 2017

(30) Foreign Application Priority Data
Sep. 5, 2014 (DE) 10 2014 106 557.3

(51) Int. Cl. F16B 15/00; F16B 19/08; F16B 37/04; F16B 15/04

(52) U.S. Cl. CPC F16B 15/0015; F16B 15/04; F16B 19/086; F16B 37/048

(57) ABSTRACT

According to the invention, a deformation base (3) is arranged on a side of a substratum (1) that is free of holes, onto which deformation base a cage part (6) has been pressed. When the cage part (6) is pressed on, foot segments (8) of the cage part (6), for example, are deformed while sliding on the deformation base and penetrate into the substratum (1), the connecting device thus being formed, and are embedded in the substrate by means of anchoring segments (14). A setting tool (21), comprising an elongate outer body (25), on which the deformation base (3) is detachably attached, and comprising an inner punch (22) that can be displaced in the outer body (25) in a longitudinal direction, to which inner punch the cage part (8) is detachably attached, is used for mechanized performance of the connecting method.

### CROSS-REFERENCE TO RELATED APPLICATION

This application is a U.S. National Phase Patent Application based on International Application Serial No. PCT/EP2015/060025 filed May 7, 2015, the disclosure of which is hereby explicitly incorporated by reference herein.

### BACKGROUND OF THE INVENTION

1. Field of the Invention

The invention relates to a connecting device.

The invention further relates to an arrangement consisting of a connecting device and a substratum. The invention further relates to a method for producing an arrangement consisting of a connecting device and a substratum. The invention further relates to a setting tool for implementing a method for producing an arrangement consisting of a connecting device and a substratum.

2. Description of the Related Art

One connecting device is known from U.S. Pat. No. 2,686,547. This known connecting device comprises a cage part, which can be connected to a substratum. Moreover, a deformation socket is provided which comprises lateral deformation surfaces, against which at least some areas of the cage part abut with positive engagement. The substratum, which is relatively thick compared to the connecting device, is configured with a recess in which the connecting device is disposed.

A further connecting device and a method for producing a connecting device with an associated setting tool are known from U.S. 2013/0340239 A1. This known connecting device comprises a cage part, which can be connected to a substratum formed from two components, wherein the cage part is brought into contact with a front side of the substratum, is pushed through a recess introduced into the substratum, is deformed by a deformation plate, which is arranged on the rear side facing away from the front side, and is brought into rear engagement with the rear side.

### SUMMARY OF THE INVENTION

The invention provides an arrangement comprising a connecting device and a method for producing this kind of arrangement, which, with the provision of a relatively thin substratum, are distinguished by a simple mounting of the cage part, a stable attachment of the connecting device to the thin substratum and a long service life of the arrangement even under relatively high long-term strain.

The invention also addresses the problem of indicating a setting tool for efficiently implementing a method for producing an arrangement that consists of a connecting device and a substratum.

Because the deformation of the cage part is carried out in the invention by means of a deformation socket that is disposed flush in a recess-free region on one side of the relatively thin substratum, the sensitive structure of the thin substratum remains largely unchanged. This results in a simple assembly with a stable attachment and a long service life of the arrangement.

In one form thereof, the present invention provides a connecting device with a cage part that can be connected to a substrate, wherein a deformation socket is provided which comprises at least one lateral deformation surface, against which at least some areas of the cage part abut with positive engagement, characterized in that the deformation socket has a bottom side which can be placed flush on a side of the substratum.

In another form thereof, the present invention provides A composite device including a cage part which is adapted to be joined with a base part, whereas the composite device further comprises a deformation base which is designed with at least one side deformation areas which contacts in a mating manner at least an area of the cage part; characterized in that the deformation base includes an underside which contacts a surface of the base part in an engagement-free manner; and characterized in that the cage part comprises a plane cover area as well as a number of foot portions joining the cover area and in that the deformation base is designed with a corresponding number of arcuate deformation areas; wherein the deformation base is adapted to be fixed with the base part by, first, arranging, in a mating manner, the cage part on the side of the deformation base facing away from the base part and, second, impressing the cage part on the deformation base in such a way that the cage part slides along the deformation base and engages the base part, wherein the tip of each foot portion is completely embedded within said base part; and characterized in that no portion of deformation base is disposed within a pre-made hole or aperture in said base part.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 3 is a perspective view, an embodiment of a claimed connecting device with a substratum so as to form an embodiment of a claimed arrangement, with a deformation socket of the connecting device, which is disposed on the substratum and comprises an internal thread, and with a cage part of the connecting device, which is engaged with the substratum;

FIG. 2 is a sectional view, the embodiment of a claimed connecting device according to FIG. 1;

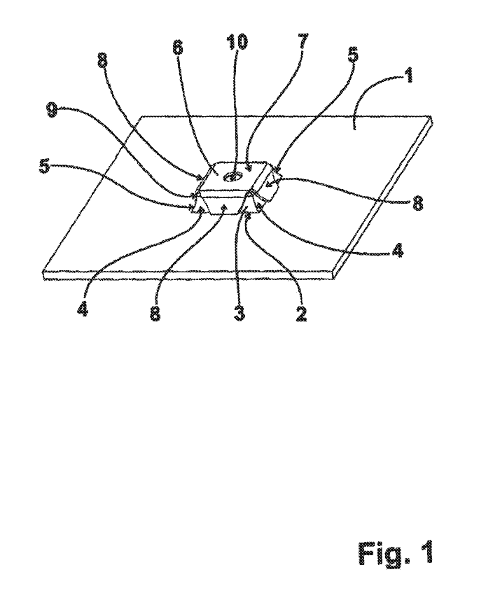

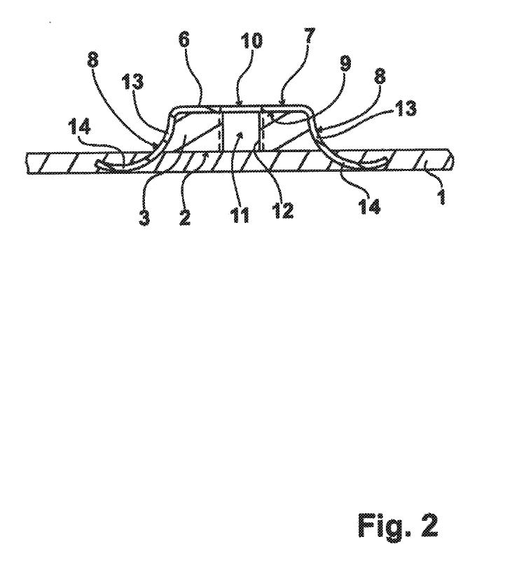

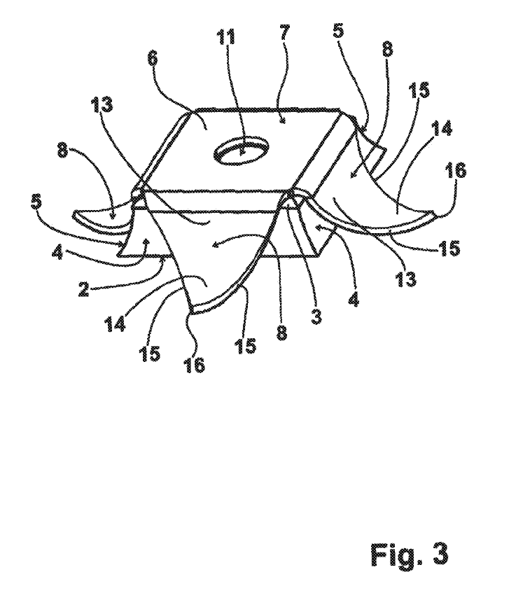

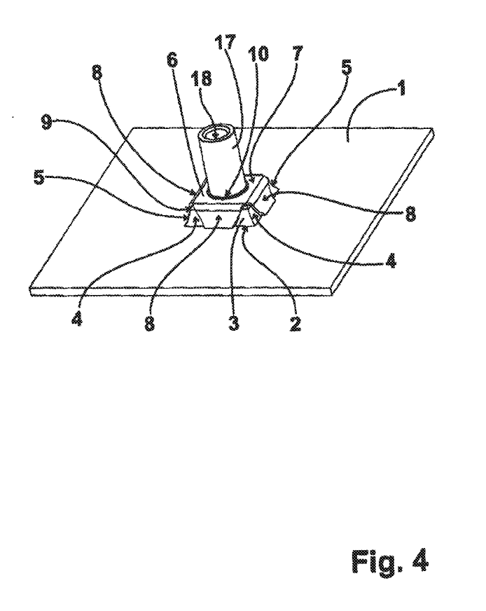

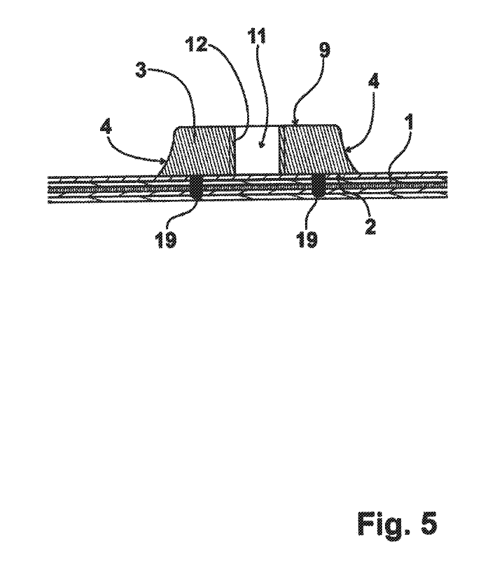

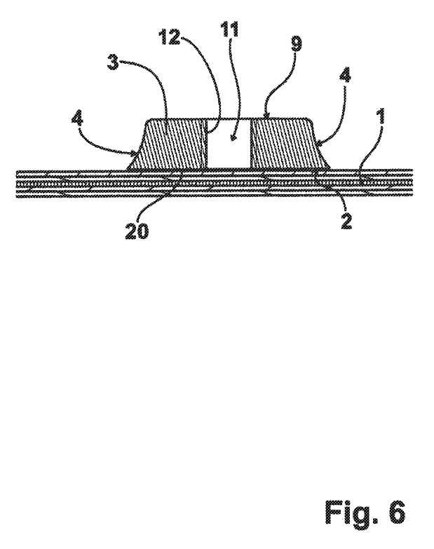

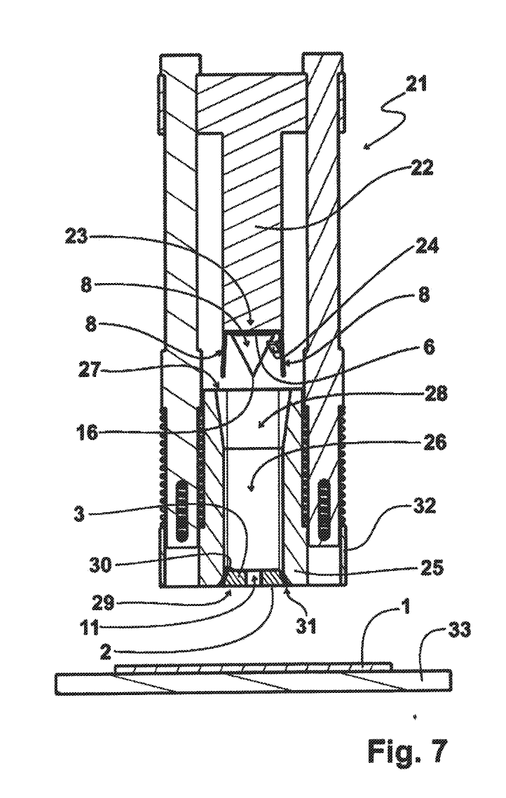

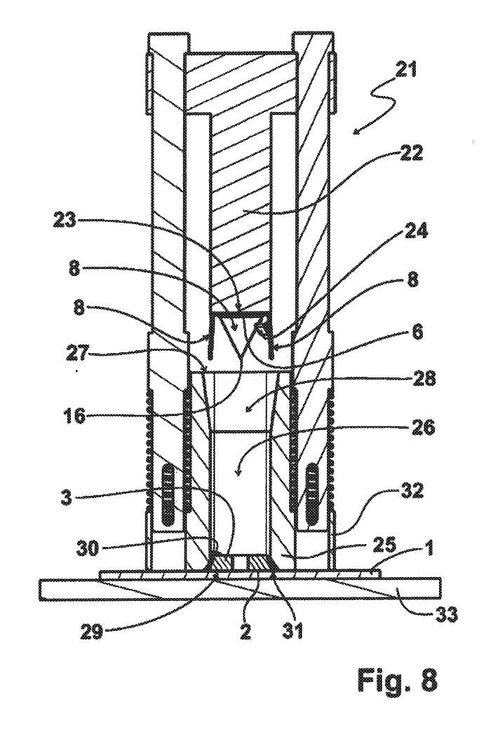

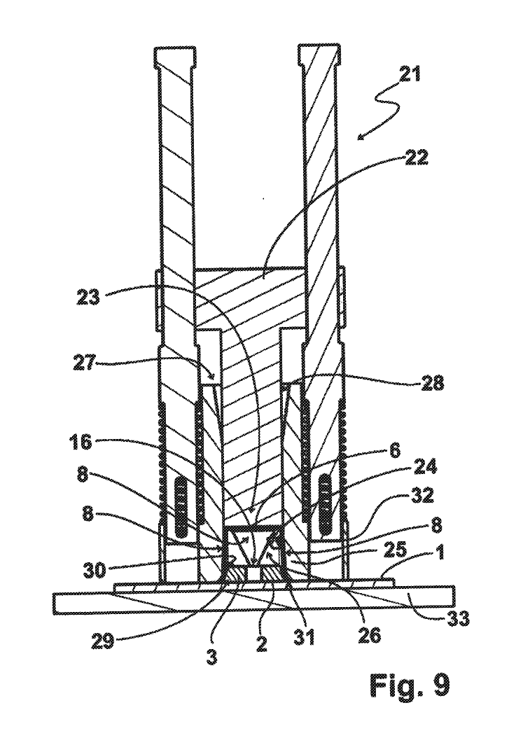

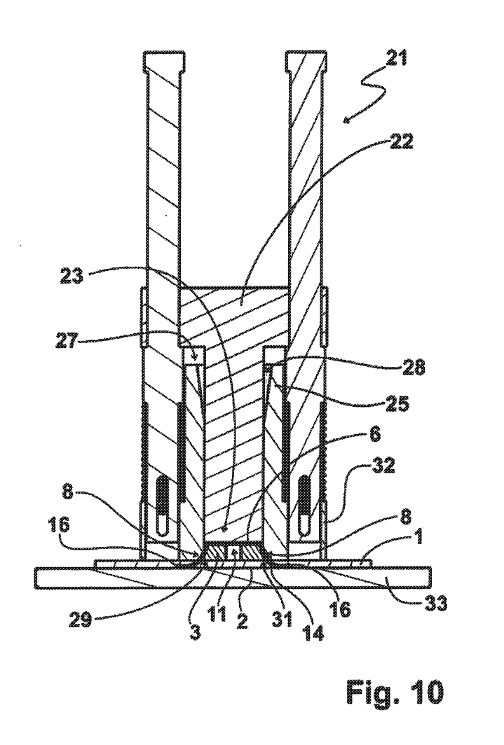

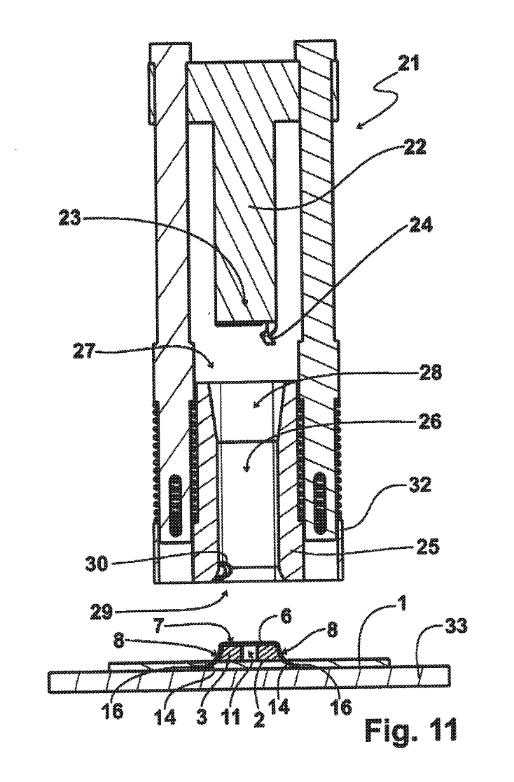

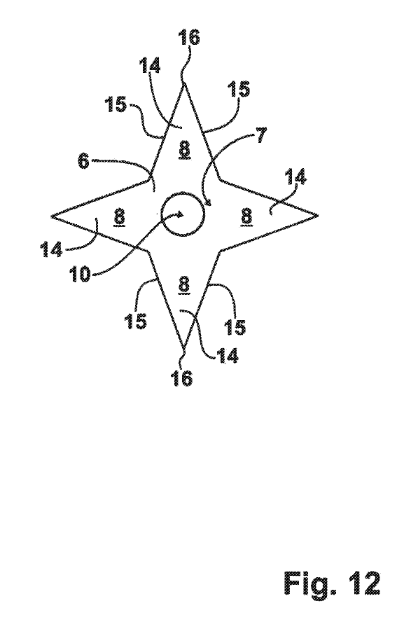

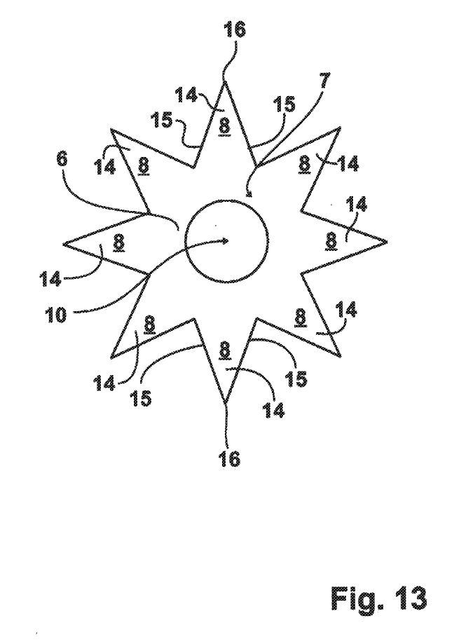

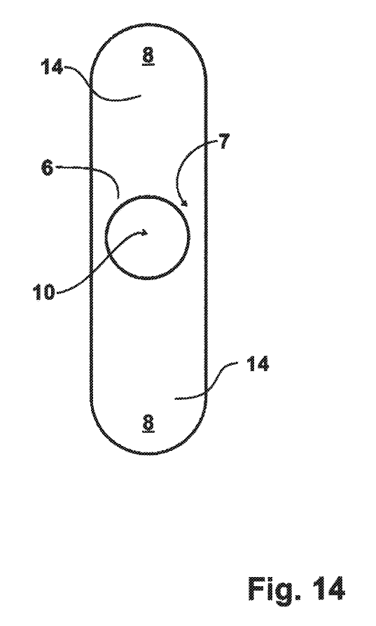

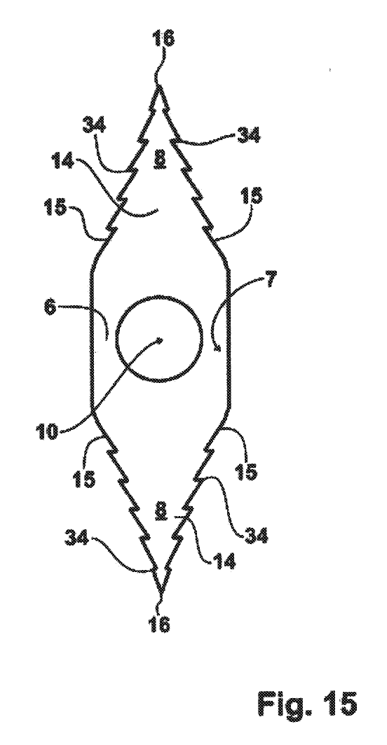

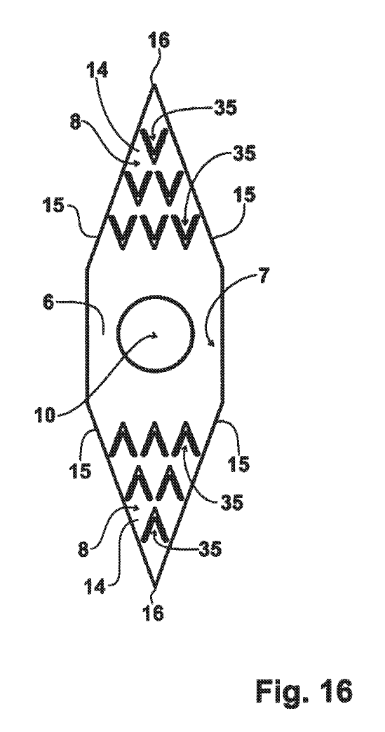

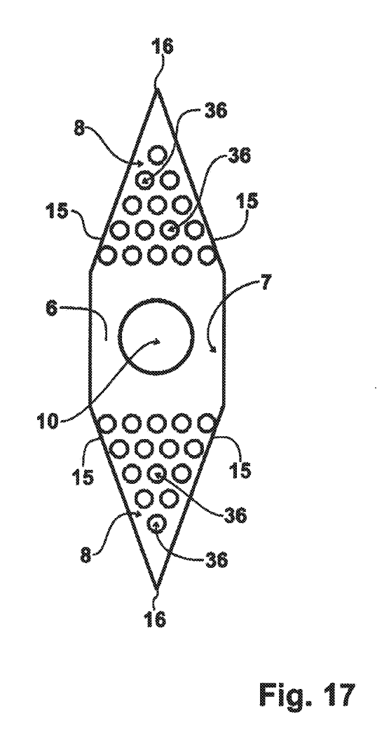

FIG. 3 is a perspective view, the embodiment according to FIG. 1 without the substratum.

FIG. 4 is a perspective view, a further embodiment of a claimed connecting device with a deformation socket, on which a threaded sleeve is integrally formed;

FIG. 5 is a sectional view, a development of the embodiment of a claimed connecting device according to FIG. 1, in which the deformation socket is configured with a plurality of mandrels;

FIG. 6 is a sectional view, a further development of the embodiment of a claimed connecting device according to FIG. 1, in which the deformation socket is bonded with adhesive to the substratum;

FIG. 7 is a sectional view, an embodiment of a claimed setting tool for implementing an exemplary claimed method, on which tool a cage part and a deformation socket of a connecting device are mounted, and a substratum for a claimed arrangement, which is disposed on an abutment plate;

FIG. 8 is a sectional view, the arrangement according to FIG. 8 with the setting tool disposed on the substratum in a pre-mounted arrangement;

FIG. 9 is a sectional view, the arrangement according to FIG. 9 with the setting tool now in an intermediate mounted arrangement;

FIG. 10 is a sectional view, the arrangement according to FIG. 10 with the setting tool now in a final mounted arrangement;

FIG. 11 is a sectional view, the arrangement according to FIG. 12 with raised setting tool;

FIG. 12 is a plan view, the cage part of the embodiment of a claimed connecting device illustrated in FIG. 1 to FIG. 3;

FIG. 13 is a plan view, a further cage part of a further embodiment of a claimed connecting device;

FIG. 14 is a plan view, a further cage part of a further embodiment of a claimed connecting device;

FIG. 15 is plan view, a further cage part of a further embodiment of a claimed connecting device;

FIG. 10 is a plan view, a further cage part of a further embodiment of a claimed connecting device; and

FIG. 17 is a plan view, a further cage part of a further embodiment of a claimed connecting device.

Corresponding reference characters indicate corresponding parts throughout the several views. Although the exemplification set out herein illustrates an embodiment of the invention, the embodiment disclosed below is not intended to be exhaustive or to be construed as limiting the scope of the invention to the precise form disclosed.

### DETAILED DESCRIPTION

FIG. 1 shows in a perspective view an embodiment of a claimed connecting device and a relatively thin substratum 1, e.g. in the form of a glass fiber mat, for forming an embodiment of a claimed arrangement. A deformation socket 3 is disposed on the substratum 1, which is formed in one layer in this embodiment, wherein said socket is disposed in a region that is free of recesses and comprises a flat lower side 2 that faces away from the observer in a representation in FIG. 1 and wherein it is manufactured as an integrally formed solid piece of metal or plastic and is thicker than the substratum 1, i.e. it is configured with greater material thickness than the substratum 1 at right angles to the substratum 1. The deformation socket 3 has a flattened cubical shape and is provided on its side with four identically configured deformation surfaces 4, which adjoin each other at abutting edges 3.

Moreover, the connecting device according to FIG. 1 comprises a cage part 6 which is manufactured e.g. of sheet metal and which is configured with a square top surface 7 and with foot segments 8, which are integrally formed on the four edge sides of the top surface 7.

In the arrangement according to FIG. 1, the top surface 7 of the cage part 6 is disposed on an upper side 9 of the deformation socket 3 that faces away from the lower side 2 of the deformation socket 3 and faces toward the observer in a representation in FIG. 1, and the top surface comprises a central head recess 10. The foot segments 8 lie against deformation surfaces 4 of the deformation socket 3 that are associated with them and penetrate into the substratum 1 in some areas.

FIG. 2 shows in a sectional view the embodiment of a claimed connecting device according to FIG. 1. It can be gathered from FIG. 2 that the deformation socket 3 is configured as an attachment structure with a central passage recess 11, which comprises an internal thread 12 on its outer side. On the upper side 9 of the deformation socket 3, the passage, recess 11 transitions into the head recess 10 of the cage part 6 so that e.g. a screw, which is not shown in FIG. 2, can be screwed into the connection device.

The top surface 7 of the cage part 6 as well as bearing regions 13 of the foot segments 8 adjacent to the top surface 7 lie against the upper side 9 and/or the deformation surfaces 4 of the deformation socket 3 with positive engagement, while engagement regions 14, which abut the bearing regions 13 on the side facing away from the top surface 7, are completely embedded in the substratum 1 as free ends of the foot segments 8 and thus solidly fix the deformation socket 3 to the substratum 1 in a recess-free region of said substratum. In this way, the bottom side 2 of the deformation socket 3 lies flush with only planar contact on the recess-free substratum 1 in said bearing region.

The flat bottom side 2 of the deformation socket 3 extends from the passage recess 11 radially outwardly in a plane such that the thin substratum 1 remains largely structurally unchanged when the free ends of the foot segments 8 are inserted, which is discussed in greater detail below, and when it is subjected to stresses that occur when it is put into use, in particular compressive/tensile stresses.

In the embodiment of a claimed connecting device shown in FIG. 1 and FIG. 2, the deformation surfaces 4 of the deformation socket 3 are curved concavely beginning from the upper side 9, and they continuously enlarge the cross-section of the deformation socket 3 from the upper side 9 toward the bottom side 2. When the cage part 6 is pressed onto the deformation socket 3 during a mounting process with foot segments 8 that, before the mounting process, are oriented at right angles to the top surface 7, said foot segments 8 slide off of the deformation surfaces 4, which widen the cross-section of the deformation socket 3 radially outwardly, and are thereby braced by a reliable engagement with the substratum 1.

In a variation not shown, the deformation surfaces 4 are flat and project obliquely downwardly from the upper side 9 to the lower side 2 of the deformation socket 3.

FIG. 3 shows in a perspective view the embodiment of a claimed connecting device according to FIG. 1 without the substratum 1. It can be gathered from the representation in FIG. 3 that the foot segments 8 of the cage part taper continuously from the top surface 7 toward the engagement regions 4, wherein foot segment side edges 15 of a foot segment 8 lying opposite each other run together at an acute angle to form a foot segment tip 16. When the foot segments 8 penetrate into the substratum 1, this results in a wedging effect, which is beneficial for an anchoring of the cage part 6 into the substratum 1 with relatively little force.

FIG. 4 shows in a perspective view a further embodiment of a claimed connecting device with a deformation socket 3, on the upper side 9 of which an elongate threaded sleeve 17 is integrally formed as an attachment structure. Said threaded sleeve 17 passes through the head recess 10 of the cage part 6 and protrudes over the top surface 7 of the cage part 6. In the embodiment according to FIG. 4, the threaded sleeve 17 is configured with an internal thread 18, into which it is possible to screw e.g. a screw, which is not shown in FIG. 4.

In a variation of the embodiment represented in FIG. 4 that is not shown in the drawings, a threaded bolt with an external thread, instead of the threaded sleeve 17, is integrally formed on the deformation socket 3 as an attachment structure, and a screw can be screwed to said threaded bolt to attach an accessory to the connecting device, for example.

FIG. 5 shows in a sectional view a development of the embodiment of a claimed connecting device, previously illustrated in FIG. 1 and FIG. 4, in which the deformation socket 3 is formed on its bottom side 2 with a plurality of mandrels 19 that protrude over the bottom side 2 at right angles and that in the substratum 1, which is multi-layered in this embodiment, and thus secure the deformation socket 3 against lateral displacement relative to the substratum 1. This is advantageous in particular during a free-hand mounting of a claimed connecting device with a substantially horizontal substratum 1, since the deformation socket 3 is fixed against an unintended lateral displacement but, if necessary, can be detached from the substratum 1 and moved before the cage part 6 is attached.

FIG. 6 shows in a sectional view a further development of the embodiment of a claimed connecting device according to FIG. 1 in which the deformation socket 3 is bonded with adhesive to a multi-layered substratum 1 by means of an adhesive layer 20, which is applied between the bottom side 2 of the deformation socket 3 and the side of the substratum 1 that faces the deformation socket development according to FIG. 6 is appropriate in particular when a reliable longlasting attachment of the deformation socket 3 to the substratum 1 is required, such as in an overhead installation.

FIG. 7 shows in a sectional view an embodiment of a claimed setting tool 21 for implementing an embodiment of a claimed method for producing a claimed arrangement of a connecting tool and a thin substratum 1. The setting tool 21 according to the embodiment in FIG. 7 comprises an elongate inner die 22 that is formed at a retaining end 23 with a plurality of cage part fixing elements 24, which are configured e.g. as leaf springs bent multiple times. As is shown in FIG. 7, the cage part fixing elements 24 are designed to detachably retain a cage part 6 of a claimed connecting device at the retaining end 23 of the inner die 22.

Furthermore, the setting tool 21 is provided with an elongate outer body 25, which comprises a cylindrical through-channel 26, to which is attached an insertion funnel 28 that expands conically toward the inner die 22 on an insertion side 27 facing the inner die 22. The cross-section of the through-channel 26 is configured such that the inner die 22, along with a cage part 6 that is attached to it, can be displaced substantially free of play within the outer body 25 when the foot segments 8 are oriented at right angles to the top surface 7.

On a supporting side 29 lying opposite the insertion side 27, the outer body 25 is equipped with a plurality of deformation socket fixing elements 30, which are configured, for example, as pins that are retractable into the outer body 25 against spring pressure and which, as is shown in FIG. 7, are designed to detachably retain a deformation socket 3 of a claimed connecting device against the outer body 25. In the process, the cross-section of the outer body 25 in the region of the support side 29 is configured such that the inner wall of the outer body 25 is spaced apart from the deformation surfaces 4 of the deformation socket 3 by a distance substantially corresponding to the material thickness of the foot segments 8 of the cage part 6. As a result, a shaping channel 31 for the foot segments 8, which deforms the foot segments 8 as the foot segments 8 pass through, is created between the deformation socket 3 and the outer body 25. For instance, the foot segments 8 are bent to a rounded shape by curved deformation surfaces 4.

The inner die 22 and the outer body 25 are attached to a usually multi-part support mechanism 32 such that the outer body 25 is fixed relative to the inner die 22 and such that the inner die 22 can be plunged into the outer body 25 and then be withdrawn from it.

Moreover, FIG. 7 shows a substratum 1 for use with a claimed connecting and for forming a claimed arrangement, which is disposed on one side of a very hard flat abutment plate 33 that faces the substratum 1.

FIG. 8 shows in a sectional view the arrangement according to FIG. 7 with a setting tool 21 now placed on the substratum 1. In this pre-mounted arrangement, the bottom side 2 of the deformation socket 3 and the support side 29 of the outer body 25 lie flat on the side of the substratum 1 opposite the abutment plate 33. Starting from this pre-mounted arrangement, the inner die 22 is moved in the direction of the outer body 25, and the cage part 6 is thus moved toward the deformation socket 3. After the foot segments 8, which necessarily project slightly radially outwardly, have entered into the insertion funnel 28, the foot segments 8 are pre-stressed radially inwardly and are introduced into the through-passage 26 in an orientation that is substantially at right angles to the top surface 7.

FIG. 9 shows the arrangement according to FIG. 7 and FIG. 8 in an intermediate mounted arrangement, in which the foot segments 8 of the cage part 6, supported by the aforementioned pre-stressing, have already partially entered the shaping channel 31, having been round bent and made contact with the substratum 1 with their foot segment tips 16. The top surface 7 of the cage part 6 is still distanced from the upper side 9 of the deformation socket 3 at this point.

FIG. 10 shows the arrangement according to FIG. 7 to FIG. 9 in a final mounted arrangement, in which the cage part 6 has been completely pressed onto the deformation socket 3 so that the top surface 7 of the cage part 6, which serves as a load application element, now rests on the upper side 9 of the deformation socket 3, the foot segments 8 with their engagement regions 14 have completely passed through the shaping channel 31, and the engagement regions 14 of the foot segments 8, having been forced into a curved shape and deflected radially outwardly by the abutment plate 33 until they are deformed toward the plane of the bottom side 2 of the deformation socket 3, have penetrated into the substratum 1 by their engagement regions 14 and are embedded in the substratum as free ends of the foot segments 8. Because the substratum 1 is designed as a so-called “preform”, the fibers are displaced laterally by this process, but the rest of the structure of the thin substratum 1 remains largely undamaged.

FIG. 11 shows the setting tool 21 according to FIG. 7 to FIG. 10 with a claimed arrangement its finished state, consisting of a connecting device and a substratum 1 that is attached to it, based on the final mounted arrangement according to FIG. 10, with the setting tool 21 removed from the substratum 1. This is possible without a significant expenditure of energy because the deformation socket 3 and the cage part 6 are detachably retained on the setting tool 21. A substratum 1 that is designed as a so-called “preform” is subsequently infiltrated in order to provide stable anchoring of the cage part 6.

FIG. 12 shows in a plan view a sheet metal cage part 6 of the embodiment of a claimed connecting device illustrated in FIG. 1 to FIG. 3 before the four foot segments 8 in this embodiment are bend pressed relative to the top surface 7. It is apparent from FIG. 12 that the cage part 6 can be produced in a single additional work step after the basic shape is punched out of the metal sheet.

FIG. 13 shows in a plan view a further sheet metal cage part 6 of a further embodiment of a claimed connecting device having a total of eight pointed foot segments 8 corresponding to the embodiment illustrated above.

FIG. 14 shows in a plan view a further sheet metal cage part 6 of a further embodiment of a claimed connecting device having two foot segments 8, which connect to the top surface 7 opposite each other. In this embodiment, the ends of the foot segments 8 that face away from the top surface 7 are rounded, which reduces the risk of damaging the structure of a substratum 1 compared to the embodiments with pointed foot segment tips 16 illustrated above.

FIG. 15 shows in a plan view a further sheet metal cage part 6 of a further embodiment of a claimed connecting device having two pointed foot segments 8, which correspond in basic shape to the embodiments according to FIG. 12 and FIG. 13, wherein a plurality of barb-like engagement projections 34 are formed as anchoring means on the side edges 15 of the foot segments, wherein said projections dig firmly into a substratum 1 after mounting and thereby increase the withdrawal force from the substrate 1 relative to the smooth-walled foot segment side edges 15.

FIG. 16 shows in a plan view a further sheet metal cage part 6 of a further embodiment of a claimed connecting device having two pointed foot segments 8, which correspond in basic shape to the embodiments according to FIG. 12 and FIG. 13, wherein a plurality of triangular engagement tabs 35 are formed in the foot segments 8 as anchoring means. Each of the triangular engagement tabs 35 is oriented with its base toward the respective foot segment tip 16 and protrudes from the plane of the foot segments 8 by the tip pointing in the direction of the top surface 7. In this way, too, the withdrawal force of the cage part 6 from the substrate 1 is increased relative to the smooth-walled foot segments 8 after mounting.

FIG. 17 shows a further sheet metal cage part 6 of a further embodiment of a claimed connecting device having pointed foot segments 8, which correspond in basic shape to the embodiments according to FIG. 12 and FIG. 13, wherein a plurality of engagement recesses 36 are formed in the foot segments 8 as anchoring means. Because the substratum 1 is designed as a so-called “preform”, the engagement recesses 36 can be permeated with resin during infiltration so that, once the connecting device has been completely assembled, the withdrawal force of the cage part 6 from the substratum 1 is increased relative to the flat-walled foot segments 8.

1-35. (canceled)

36. A composite device, comprising:
a base part having a surface;
a cage part joined to the base part, the cage part including a planar cover area and a plurality of foot portions joined to the cover area;
a deformation base including a plurality of deformation areas corresponding in number with the plurality of foot portions of the cage part, the deformation base further including an underside which contacts the surface of the base part in an engagement-free manner; and
wherein the deformation base is fixed to the base part by arranging the cage part on a side of the deformation base facing away from the base part and impressing the cage part on the deformation base to slide the foot portions of the cage part along the deformation areas of the deformation base and into engagement with the base part, with a tip of each foot portion completely embedded within the base part and the deformation base not disposed within a pre-made hole or aperture in said base part.

37. The composite device of claim 36, wherein neither the base part nor the cage part is disposed over a pre-made hole or aperture in said base part.

38. The composite device of claim 36, wherein at least one of the foot portions includes fixing means.

39. The composite device of claim 36, wherein each deformation area is arcuately curved in radial direction to the outside.

40. The composite device of claim 36, wherein each deformation area is arcuately outwardly inclined.

41. The composite device of claim 36, wherein prior to arranging and impressing, the deformation base and the cage part are adapted to be arranged in a mounting tool.

42. The composite device of claim 36, wherein prior to impressing, the deformation base is adapted to be secured to the base part.

43. The composite device of claim 42, wherein the deformation base is adapted to be secured to the base part by an adhesive layer.

44. The composite device of claim 42, wherein the deformation base is adapted to be secured to the base part an engagement structure provided at its underside.

45. The composite device of claim 44, wherein the engagement structure includes at least one spike projecting from an underside of the engagement structure.

46. The composite device of claim 36, wherein the deformation base includes a fastening structure.

47. An arrangement including the composite device and a base part of claim 36, wherein the composite device is thicker than the base part and the deformation base includes a planar underside which joins engagement-free an area of the base part which is free from recesses.

48. The composite device of claim 36, wherein during impressing, the deformation base and the cage part are arranged in a mounting tool.

49. The composite device of claim 48, wherein the mounting tool includes an elongated outer body and an inner piston arranged within the outer body in a sliding manner in a longitudinal direction and wherein the outer body is adapted to detachably hold the deformation base and the inner piston is adapted to detachably hold the cage part.

50. The composite device of claim 49, wherein the mounting tool includes a forming channel between the outer body and the deformation base for deforming the foot portions of the cage part.

51. The composite device of claim 49, wherein the mounting tool includes an outer body and the inner piston is arranged on a support unit.
